(19) United States
(12) Patent Application Publication
(10) Pub. No.: US 2008/0098803 A1
(43) Pub. Date: May 1, 2008

(54) Thermal Effect Switch

(76) Inventor: Jsun Lin Wei, Longtan Township (TW)

Correspondence Address: HDSL, 4331 STEVENS BATTLE LANE, FAIRFAX, VA, 22033, US

(21) Appl. No.: 11/553,990

(22) Filed: Oct. 27, 2006

(51) Int. Cl. G01N 25/56; G01N 5/02

(52) U.S. Cl. 73/75

(57) ABSTRACT

A thermal effect switch in accordance with a preferred embodiment includes a thermal chamber and an effect switch mounted on the thermal chamber. The thermal chamber has a sealed chamber and working fluid filled therein. The sealed chamber has a vacuum chamber. The effect switch is a flexible structure configured for turning inwards and outwards, and is operated by changing inner pressure of the thermal chamber produced by heating the thermal chamber. The thermal effect switch can drive the effect switch according to the heat condition of the thermal chamber.

### BACKGROUND OF THE INVENTION

1. Field of the Invention

The present invention relates to thermal effect switches for the application technology using the thermal conductance in automatic reaction switches and warning switches etc.

2. Description of the Related Art

In recent years, thermal chambers are usually used in electronic products, such as computers, etc., to be configured for conducting heat. The thermal chamber is a sealed chamber and has a little working fluid filled therein. The sealed chamber includes a vacuum chamber. A capillary construction is attached on the inner wall of the sealed chamber. If one distal end of the thermal chamber is heated, the working fluid filled therein will be vaporized and transmitted to the other distal end. In the transmitting process, the vaporized working fluid is cooled to be liquid and the heat dissipates. The conventional thermal chamber is only used to conduct heat, and have no else uses.

What is needed, is to provide a thermal effect switch using a thermal chamber.

### BRIEF SUMMARY

A thermal effect switch in accordance with a preferred embodiment includes a thermal chamber and an effect switch mounted on the thermal chamber. The thermal chamber has a sealed chamber and working fluid filled therein. The sealed chamber has a vacuum chamber. The effect switch is a flexible structure configured for turning inwards and outwards, and is operated by changing inner pressure of the thermal chamber produced by heating the chamber.

A thermal effect switch in accordance with another preferred embodiment includes a thermal chamber and an effect switch mounted thereon. The thermal chamber has a sealed chamber and working fluid filled therein. The sealed chamber has a vacuum chamber. The effect switch is configured for send out an output signal produced according to the heat condition of the thermal chamber to form an open circuit or a close circuit.

The present thermal effect switch uses an effect switch operated by the heat condition of the thermal chamber, so that the thermal effect switch can sense the heat condition. Furthermore, in the present invention, an alarm device is provided, and is driven by the above thermal effect switch. The alarm device includes a circuit controlled by the effect switch. The alarm device includes a moveable plate, two electrical conductive columns passing through the moveable plate, a power supply and an alarm. The power supply and the alarm are arranged between the two electrical conductive columns. The alarm may be a light emitting element, a sound element or a shake element. The switch moves outwards controlled by the heat condition of the thermal chamber to make the moveable plate contact with the two electrical conductive columns to form a close circuit, thereby, the alarm sends out an alert.

Other objects, advantages and novel features of the invention will become more apparent from the following detailed description when taken in conjunction with the accompanying drawings, in which:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, exploded view of a thermal effect switch in accordance with a first preferred embodiment of the present invention;

FIG. 2 is a schematic, cross-sectional view of the thermal effect switch of FIG. 1;

FIG. 3 is an active, cross-sectional view of the thermal effect switch of FIG. 2;

FIG. 4 is a schematic, cross-sectional view of an alarm device driven by the thermal effect switch;

FIG. 5 is an active, cross-sectional view of the alarm device of FIG. 4;

FIG. 6 is a partial exploded view of the alarm device of FIG. 4;

FIG. 7 is a schematic view of a spoon using the alarm device; and

FIG. 8 is a schematic, exploded view of a thermal effect switch in accordance with a second preferred embodiment of the present invention.

### DETAILED DESCRIPTION

Reference will now be made to the drawings to describe a preferred embodiment of the present thermal effect switch, in detail.

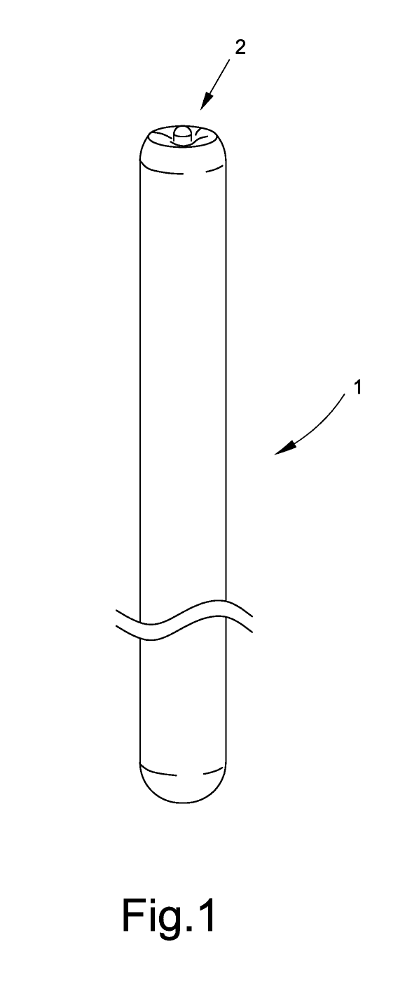

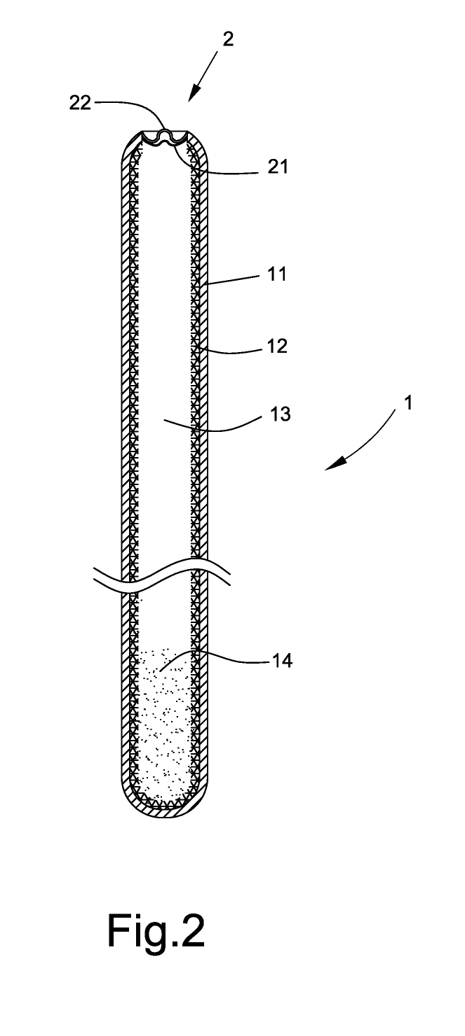

Referring to FIGS. 1, 2 and 3, a thermal effect switch in accordance with a first preferred embodiment of the present invention is shown. The thermal effect switch includes a thermal chamber 1 and an effect switch 2 mounted on the thermal chamber 1. The thermal chamber 1 includes a sealed chamber 11 and a capillary structure 12 attached on the inner wall of the sealed chamber 11. The capillary structure 12 may be instead of a hydrophilic coating. The sealed chamber 11 has a vacuum chamber 13 and a little working fluid 14 filled therein.

The effect switch 2 is arranged at an optional place of the thermal chamber 1. The effect switch 2 includes a middle protruding portion 22, and a flexible portion 21 arranged around the periphery of the protruding portion 22. The flexible portion 21 can turn inwards or outwards to make the protruding portion 22 move downwards or upwards.

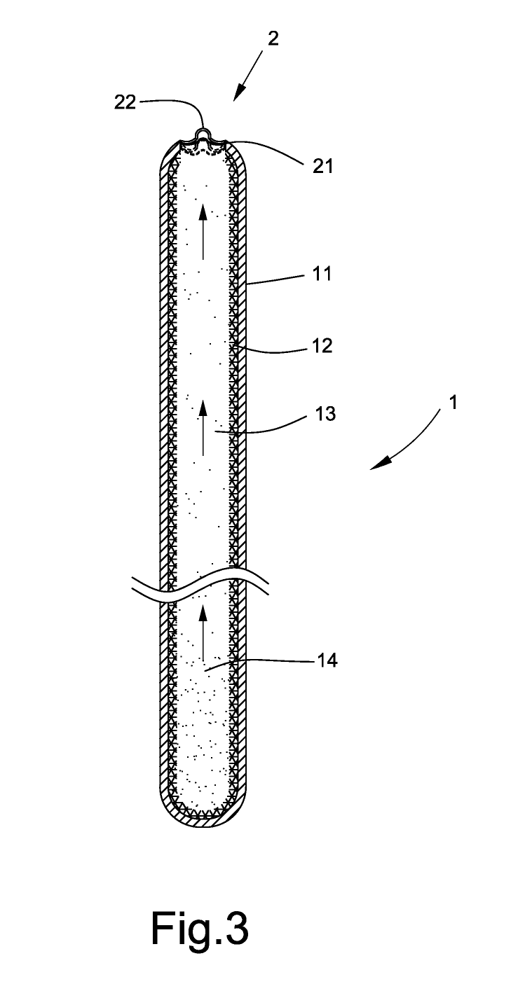

Referring to FIG. 3, if a distal end of the thermal chamber 1 is heated, the working fluid 14 filled therein transforms into steam and moves quickly along the vacuum chamber 13 to dissipate heat. In this process, the inner pressure of the thermal chamber 1 changes, thereby, the effect switch 2 turns outwards since the inner pressure increases. Therefore, the effect switch 2 can be driven by the heat condition of the thermal chamber 1.

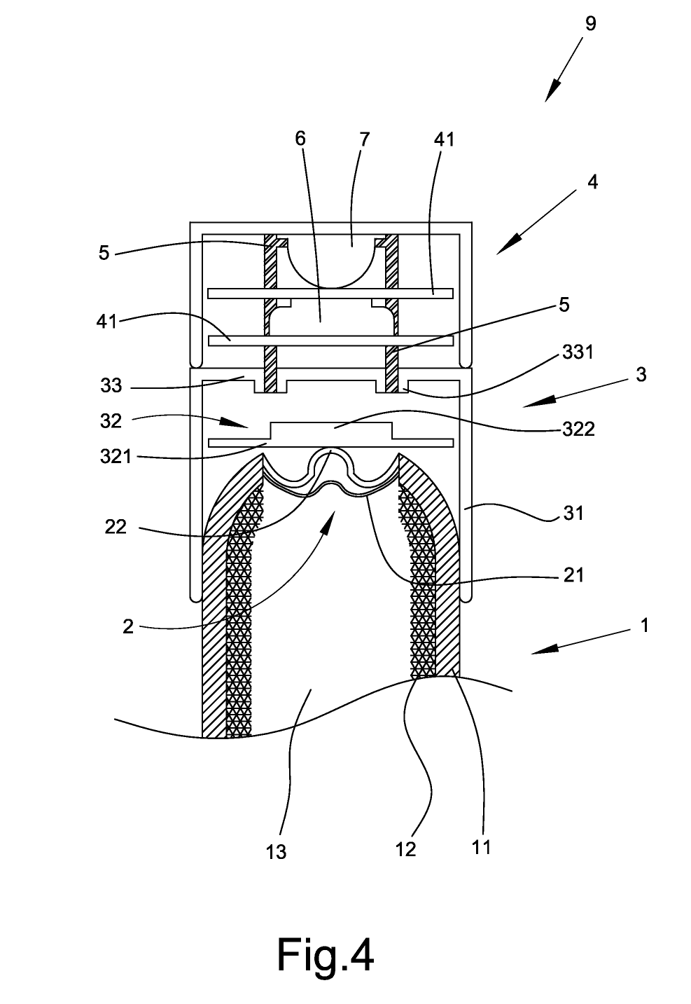

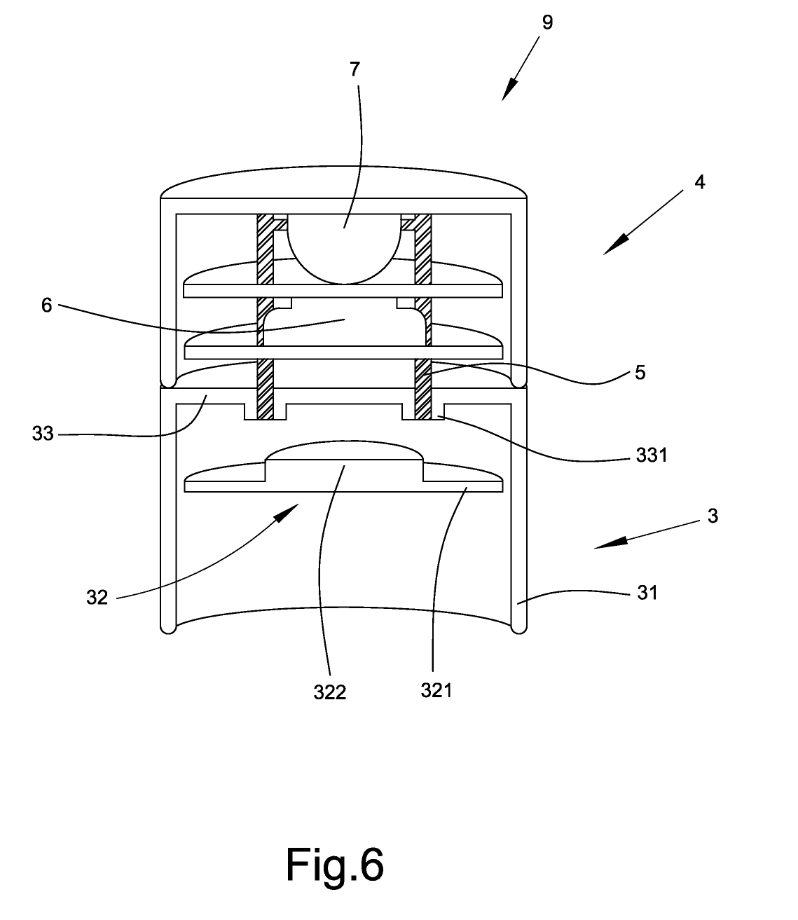

Referring to FIGS. 4 and 6, an alarm device 9 driven by the above thermal effect switch 1 is shown. The alarm device 9 includes a component unit 3 and an alarm unit 4.

The component unit 3 is used to receiving the effect switch 2 of the thermal effect switch 1. The component unit 3 includes a top plate 33 and a sidewall 31 surrounding the top plate 33. A movable plate 32 is arranged under the top plate 33 and in a space defined by the sidewall 31. The movable plate 32 includes a flat plate 321 and an electric conductive protrusion 322. The flat plate 321 is arranged at the fringe of the effect switch 2.

The alarm device 9 further includes two electrical conductive columns 5 perpendicular to the top plate 33 and passing through the top plate 33. Each electrical conductive column 5 has a conductive portion 331 arranged at the bottom thereof.

The alarm unit 4 is arranged on the component unit 3 and includes a number of clapboards 41. The two electrical conductive columns 5 pass through the number of clapboards 41. The alarm unit 4 further includes a power supply 6 and an alarm 7 arranged on the clapboards 41. The power supply 6 may be a battery and the alarm 7 may be a light emitting element, such as light bulb or light emitting diode. The alarm 7 also may be a sound element, such as trumpet or buzzer. The alarm 7 may be also a shake element with a shake function. The alarm unit 4 further includes a printed circuit board (not shown).

Referring to FIG. 4, if the thermal chamber 1 is not heated or is not over a predetermined temperature, the effect switch 2 is not driven to turn outwards and the protrusion 322 does not contact the two conductive portions 331. Therefore, the two electrical conductive columns 5 with the protrusion 322 and two conductive portions 331 form an open circuit so that the alarm 7 will not send out an alert.

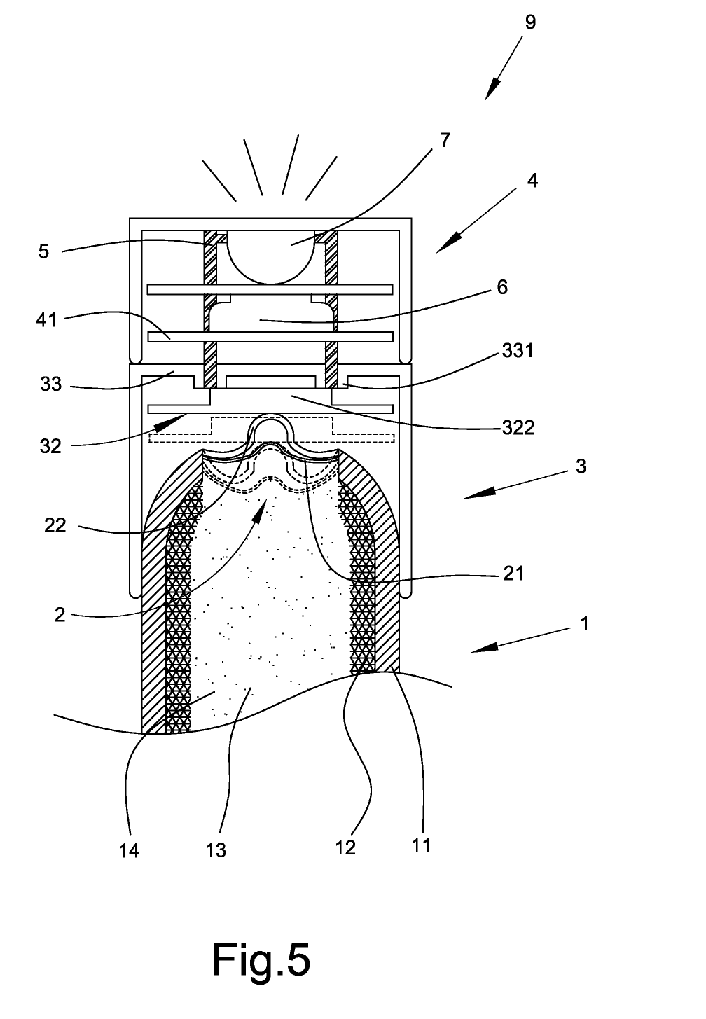

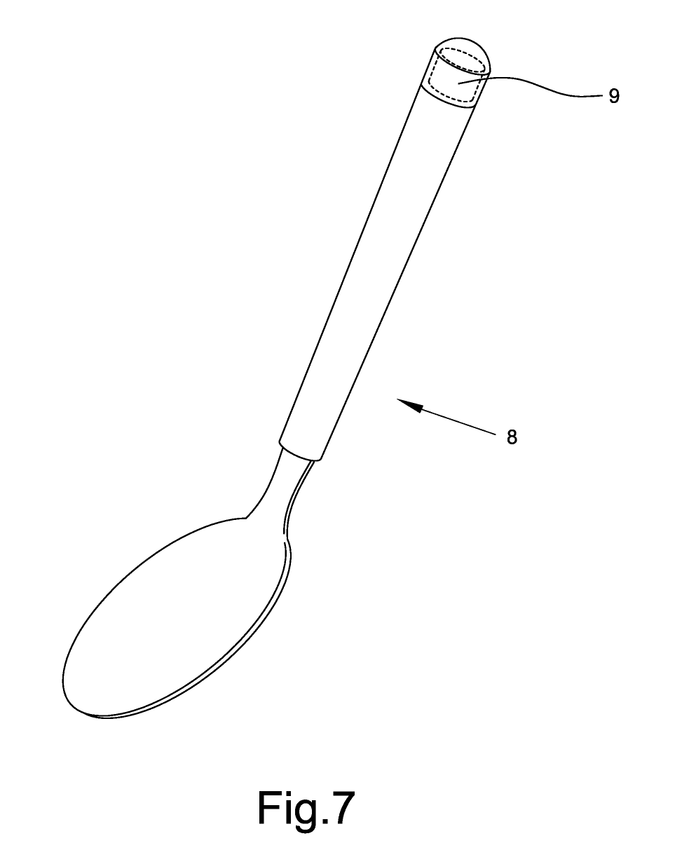

Referring to FIG. 5, if the thermal chamber 1 is heated to be over the predetermined temperature, the effect switch 2 turns outwards since the inner pressure increases, to make the protrusion 322 move upwards by the protruding portion 22 pushing. Then the protrusion 322 contacts with the two conductive portions 331. Thereby, the two electrical conductive columns 5 with the protrusion 322 and the two conductive portions 331 form a close circuit since the two conductive portions 331 is made of an electric material. The alarm 7 sends out an alert, such as light, sound or shake, etc. The alarm device 9 can be used in a spoon 8 as shown in FIG. 7. The spoon includes the alarm device 9 arranged at one distal end thereof. If the spoon 7 feels a heat source over the predetermined temperature, the alarm device 9 will send out an alert to avoid scalding tongue and mouth.

The present alarm device 9 can be used not only in the spoon, but also in other product which influences by the heat, such as dishwares, or fire protections, etc.

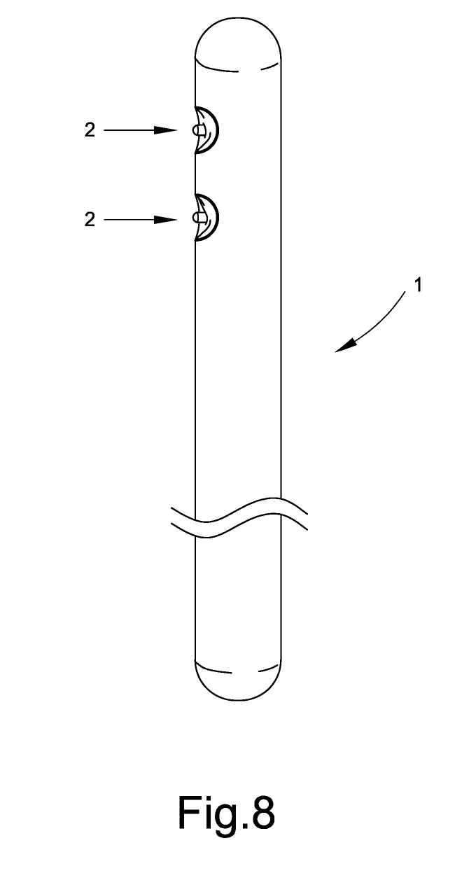

The effect switch 2 can be arranged not only at one distal end of the thermal chamber 1, but also at a sidewall of the thermal chamber 1 as shown in FIG. 8. The thermal effect switch may include a number of switches 2 arranged at different places of the thermal chamber 1. Furthermore, the number of switches 2 may be designed and controlled by different predetermined temperatures. For example, a thermal effect switch includes the number of switches 2 mounted on the single thermal chamber 1. A switch A is designed and driven by a temperature over 27 degrees centigrade, and be connected with a fanner. A switch B is designed and driven by another temperature over 30 degrees centigrade, and connected with an air conditioner. Therefore, if the room temperature is over 27 degrees centigrade, the switch A will be driven to activate the fanner. Furthermore, if the room temperature is over 30 degrees centigrade, the switch B will be driven to activate the air conditioner.

The thermal chamber 1 is a sealed chamber having any shape, length, construction, and material. The effect switch 2 may also have any shape, construction, number and material. The thermal effect switch may have different working fluid, capillary structure and vacuum pressure decided by different characters of the thermal effect switch. The thermal effect switch may have or have not a capillary structure. The alarm unit may also replace its inner component.

The switch may also be a switch sending out a signal to form an open circuit or a close circuit decided by the heat condition of the thermal chamber.

The conductive portion may also be an embedding electrode.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A thermal effect switch, comprising:
a thermal chamber, the thermal chamber having a sealed chamber and a working fluid filled therein, the sealed chamber being a vacuum chamber; and
an effect switch mounted on the thermal chamber, the switch being a flexible structure configured for turning inwards and outwards,
wherein the switch is operated by changing an inner pressure of the thermal chamber produced by heating the thermal chamber.

2. The thermal effect switch as claimed in claim 1, wherein the effect switch comprises a protruding portion and a flexible portion arranged at a periphery of the protruding portion.

3. The thermal effect switch as claimed in claim 1, wherein the effect switch is arranged at a distal end of the thermal chamber.

4. The thermal effect switch as claimed in claim 1, wherein the effect switch is arranged at a sidewall of the thermal chamber.

5. The thermal effect switch as claimed in claim 1, further comprising an alarm device encasing the heat effect, the alarm device comprising:
a component unit configured for containing the effect switch, the component unit having a top plate, a sidewall surrounding the top plate, and a moveable plate arranged under the top plate and in a space defined by the sidewall, the moveable plate having at least one electric conductive protrusion;
two electrical conductive columns perpendicular to the top plate and passing through the top plate, each electrical conductive column having a conductive portion arranged at the bottom thereof; and
an alarm unit arranged on the component unit and passed through by the two electrical conductive columns, the alarm unit having a power supply and an alarm arranged between the two electrical conductive columns,
wherein the alarm is configured for sending out an alert by the effect switch pushing the movable plate to form a close circuit between the two electrical conductive columns.

6. The thermal effect switch as claimed in claim 5, wherein the power supply is a battery.

7. The thermal effect switch as claimed in claim 5, wherein the alarm is a light emitting element.

8. The thermal effect switch as claimed in claim 7, wherein the light element is selected form a group consisting of a light bulb and a light emitting diode.

9. The thermal effect switch as claimed in claim 5, wherein the alarm is selected form a group consisting of a sound element, a shake element and their combination.

10. The thermal effect switch as claimed in claim 9, wherein the sound element is selected from a group consisting of a trumpet and a buzzer.

11. The thermal effect switch as claimed in claim 5, wherein the alarm unit further comprises a printed circuit board.

12. A thermal effect switch, comprising:
a thermal chamber, the thermal chamber having a sealed chamber and working fluid filled therein, the sealed chamber being a vacuum chamber; and
an effect switch mounted on the thermal chamber, the effect switch being configured for send out an output signal produced according to the heat condition of the thermal chamber to form an open circuit or a close circuit.

13. The thermal effect switch as claimed in claim 12, further comprising an alarm device connected with the effect switch to send out an alert controlled by the effect switch.

14. The thermal effect switch as claimed in claim 13, wherein the alert sent out from the alarm device is selected from a group consisting of a sound signal, a light signal, a shake signal and their combination.

15. The thermal effect switch as claimed in claim 12, wherein the effect switch is arranged at one distal end of the thermal chamber.

16. The thermal effect switch as claimed in claim 12, wherein the effect switch is arranged at a sidewall of the thermal chamber.

17. The thermal effect switch as claimed in claim 1, wherein the thermal chamber comprises a capillary structure or a hydrophilic coating.

18. The thermal effect switch as claimed in claim 12, wherein the thermal chamber comprises a capillary structure or a hydrophilic coating.
